(19) United States
(12) Patent Application Publication
(10) Pub. No.: US 2007/0136593 A1
(43) Pub. Date: Jun. 14, 2007

(54) Secure information storage apparatus

(76) Inventors: Richard Plavcan, Glen Mills, PA (US); Angela M. Brilis, Glen Mills, PA (US)

Correspondence Address: ROBERT J. YARBROUGH, ATTORNEY AT LAW, 201 NORTH JACKSON STREET, MEDIA, PA, 19063, US

(21) Appl. No.: 11/302,613

(22) Filed: Dec. 14, 2005

(51) Int. Cl. H04L 9/00

(52) U.S. Cl. 713/172

(57) ABSTRACT

The Invention is a secure data storage and retrieval apparatus. The device features a microprocessor, a long term memory, a temporary memory, a display and a plurality of buttons. A user gains access to the long term memory by selecting a decryption key utilizing only the plurality of buttons. The user can create, store and retrieve encrypted data files to and from long term memory by selecting the decryption key using the plurality of buttons. The encrypted information stored on long term memory is not otherwise available

### BACKGROUND

1. Field of the Invention

The invention is a secure information storage apparatus for securely storing information. The secure information storage apparatus of the Invention is readily portable and is particularly useful for securely storing and retrieving alphanumeric characters such as passwords, access codes, financial account numbers, sensitive contact information and the like.

2. Description of the Prior Art

The widespread use of computers, computer networks and computer operated devices allows information to be shared as never before. The same widespread use of computers has created new categories of destructive activity;

namely, hacking, identity theft, computer fraud and disruption of critical information services. As modern society becomes ever more dependent upon computers, information security becomes ever more important.

Passwords are frequently used to control access to confidential systems. To restrict access to, say, a personal computer using a password, the computer is programmed to allow access only if the correct password is input into the computer at the proper time. A computerized security system may unlock an entry/exit door only if the proper password is input into the security system by a person seeking entry. Frequently, a person seeking access to a confidential system is required to input both a correct user name and the password associated with that user name.

A “password” is not necessarily a word and a “user name” is not necessarily the name of a user. For purposes of this application, the terms “password” and “user name” both mean any sequence of patterns or symbols of any length. As used in this application, the term “symbol” means any unique indicia that may be distinguished from any other indicia. For example and without limitation, ‘symbols’ include lower case letters, upper case letters, numerals, punctuation, spaces, letters of the Greek or Cyrillic alphabets, Chinese or Korean characters, made-up or otherwise arbitrary indicia, or any mark that may be distinguished from another mark. As used in this application, the term “patterns” means any sequence of actions or occurrences capable of identifying a user, whether or not the sequence has an associated symbol. The term “patterns” includes, without limitation, a sequence of button depressions on a keypad, a sound and an image.

The limits of the memory of the user present the greatest obstacle to reliable and secure access control using passwords consisting of symbols. Good security practice requires the user to select a password consisting of a lengthy, distinct sequence of symbols for each secure system or machine to which the user may require access. The most secure passwords are those that contain many symbols in a sequence that has no intrinsic meaning. Unfortunately, these are also the passwords that are the most difficult to remember.

The user constantly must balance the need for security against the need to actually access the system protected by the password. A user may seek to ease his or her task by selecting short passwords, by selecting passwords that have some association to the user, such as a name or word, or by assigning the same password to a variety of security applications.

An invader may defeat a short password by the brute force approach of trying all the various combinations of symbols. The invader may speed his or her task by removing the microprocessor protected by the password from its housing and connecting the leads of the microprocessor directly to another computer, such as a supercomputer. The supercomputer then may present possible passwords to the microprocessor electronically. The invader may deduce a password having an association for the user through the invader's knowledge of the user. Use of one password for many applications jeopardizes security by providing many opportunities for failure for the password and greater damage if the single password is compromised.

Even the diligent user who dutifully selects many different, lengthy, arbitrary passwords may create information security problems. Such a user is tempted to write down the passwords, either on paper or in a computer file, rather than risk loss of the information or access provided by the passwords. Passwords written on paper carry the obvious risk of loss, theft or copying. Passwords maintained in a computer file are only as secure as is access to the computer file and are at risk from hacking.

In short, the memory of the user is the weak link in the use of passwords to protect information. The same issues of memory and security apply whenever a user is required to remember any confidential series of symbols. Other examples include a financial institution account number, a personal identification number for a bank or credit card, a key number, a security code, a combination to a combination lock, a date, a telephone number or an address.

Portable encryption devices are known in the art. For example, a USB flash drive that utilizes encryption and a login from a computer into which the flash drive is inserted is sold under the name CryptoStick by Research Triangle Software, Inc. A USB flash drive that incorporates encryption and a fingerprint reader is marketed by Sony Corporation under the name Micro Vault®.

The CryptoStick, Micro Vault® and all such prior art devices (hereinafter, ‘encrypted drives’) are capable of being used with multi-tasking computers, such as personal computers. The multi-tasking nature of the personal computer renders information stored on any encrypted drive vulnerable to attack. All encrypted drives result in decrypted data being stored in the temporary memory of the personal computer, where the information is available to any program running on the personal computer. The decrypted data in temporary memory then may be compromised by malicious software or by an invader secretly accessing the personal computer through a port.

The CryptoStick and other devices that rely on a computer keyboard are vulnerable to key loggers. A ‘key logger’ is malicious software or a device that connects to a personal computer and records all key depressions on the computer keyboard. An invader can use a key logger to steal passwords, including passwords to the encrypted drive. The invader can thereby breach the encrypted drive.

The peripheral nature of the biometric sensor devices, such as the finger-print actuated Micro Vault®, also renders the devices to which they are connected vulnerable to attack. The electronic signal sent to the personal computer by the Micro Vault® or similar device can be observed and duplicated. An invader can use the duplicate electronic signal to impersonate an authorized user.

No prior art device provides the portability, degree of security and freedom from vulnerabilities of the present invention.

### SUMMARY OF THE INVENTION

The Invention is a secure information storage apparatus for securely storing confidential information with complete security while allowing ready access to the confidential information by a user. As used in this application, the term “confidential information” means any sequence of patterns or symbols, as defined above, to which a user seeks to maintain confidential access, including, without limitation, a password, combination, account number, personal identification number, date, telephone number, address, or writing. The Invention is also a method for securely storing confidential information with complete security.

The secure information storage apparatus comprises a case containing a microprocessor, a power supply, a long term memory, an LCD screen, a port and a plurality of buttons. The plurality of buttons may comprise a plurality of touch locations on a touch screen. The microprocessor is programmed to receive plain text confidential information through the buttons, to encrypt the received confidential information and to store the encrypted information in the long term memory. The encrypted information may be decrypted and displayed to the user on the LCD screen only upon the entry of a login phrase by the user using the buttons. As used in this application, a “login phrase” is a password as defined above. The login phrase will comprise all or part of a decryption key. As used in this application, the term “LCD screen” means a display appearing on the case of the secure information storage apparatus and controlled by the microprocessor.

The encrypted information may be backed-up to the memory of a PC in encrypted form. The decrypted information may not be displayed in any fashion other than on the LCD screen of the secure information storage apparatus and may not be downloaded from the secure information storage apparatus through the port.

Any of a number of available cryptographic algorithms is suitable for use to encrypt the confidential information. For example, the information vault may utilize block ciphers such as the Data Encryption Standard (“DES”), RC2 by RSA Data Security, Triple DES, Triple DES with two keys, Advanced Encryption Standard (“AES”) or RC4. Alternatively, the information vault may utilize hash algorithms such as the Secure Hash Algorithm (“SHA”). The encryption key may be a public key and the decryption key may be a private key. In this event, the public encryption key may remain resident in the memory of the apparatus, since the public encryption key is of no help to an attacker in decrypting the information. Any combination of symbols (as defined above and including spaces) may be used as a login phrase, consistent with the decryption key requirements of the cryptographic algorithm selected.

If the login phrase comprises a description key that is five symbols in length and for which each of the five symbols may be selected from among one hundred possible symbols, a total of ten billion different decryption keys are possible. If the apparatus is stolen, a motivated invader may attempt a brute force attack by trying all possible decryption keys. All available encryption schemes potentially are vulnerable to such a brute force attack. The secure information storage apparatus avoids any significant risk from a brute force attack by counting unsuccessful attempts to enter a decryption key. If the microprocessor counts a predetermined number of unsuccessful attempts, say one hundred attempts, the microprocessor automatically erases the encrypted memory, destroying the confidential information and thwarting the invader. For the five symbol decryption key, erasing the memory after one hundred unsuccessful attempts means that an invader has a one in 100 million chance of successfully using a brute force attack to breach the secure information storage apparatus. A successful entry of the access code resets the counter, preventing inadvertent erasure of the encrypted confidential information. Any suitable number of unsuccessful attempts may be selected to trigger erasure of the encrypted memory.

The invader cannot defeat the unsuccessful login counter by turning off the power to the secure information storage apparatus. The microprocessor is configured so that if an invader attempting a brute force attack turns the secure information storage apparatus off or removes the battery, the counter for unsuccessful attempts is not reset. When the invader turns the unit back on or replaces the battery, the counter continues to count unsuccessful login attempts where it left off.

The buttons may comprise a full alphanumeric keypad; however, a more abbreviated keypad is suitable. Six buttons are considered completely adequate for the purposes of the secure information storage apparatus and even fewer buttons may be suitable.

The secure information storage apparatus is portable and is small enough to fit easily in a pocket or purse. The secure information storage apparatus may be configured to incorporate a key ring, pocket or belt clip or a lock. The user is required to remember only a single password—the login phrase for the secure information storage apparatus.

By way of example, the user may be a computer systems administrator for a large, high-security organization with offices in several locations. The user may be in charge of hundreds of client computers, each of which has (or should have) a separate security code. To access a computer, the administrator retrieves the secure information storage apparatus from his or her pocket and enters the login phrase using the buttons. The secure information storage apparatus applies the login phrase as a decryption key and decrypts the encrypted files contained in long term memory of the secure information storage apparatus. The administrator navigates through the menu presented on the LCD screen to locate the decrypted security code in question. The administrator then enters the security code into the computer, which allows the administrator access.

When finished, the administrator turns off the secure information storage apparatus, which erases the temporary memory and thereby destroys the decrypted confidential information. The encrypted information is retained on the secure information storage apparatus long term memory, ready for further use. The administrator may turn off the secure information storage apparatus through any conventional means, including manually instructing the apparatus to shut down or by providing a timer that automatically turns the secure information storage apparatus off after the passage of a pre-determined period of time.

If the apparatus is lost or stolen, the administrator does not have to worry about the security of his or her confidential information. The confidential information exists only as encrypted files on the secure information storage apparatus long term memory. If an invader attempts to view the confidential information using the LCD screen, the secure information storage apparatus refuses to allow access to the information. If the invader connects the port of the apparatus to a PC and attempts to download the encrypted confidential information, the apparatus refuses to allow the download. If invader attempts a brute force attack by inputting every possible decryption key, the secure information storage apparatus counts to a pre-determined number of unsuccessful attempts, say, 100 attempts, and then automatically erases the encrypted files. Furthermore, if an invader attempts a brute force attack by removing the microprocessor and connecting the leads of the microprocessor directly to another computer, such as a supercomputer, the information remains encrypted with the automatic multiple attempt erase feature, preventing access.

To back up the secure information storage apparatus, the administrator connects the secure information storage apparatus to a personal computer (“PC”) or other back up device through the port. The administrator logs onto the secure information storage apparatus and instructs the apparatus to download the encrypted confidential information. The secure information storage apparatus delivers the encrypted confidential information to the port and the PC receives and records the encrypted confidential information.

If the apparatus is lost or stolen, the administrator does not lose access to his or her confidential information. The administrator merely purchases a new secure information storage apparatus, programs the new secure information storage apparatus to accept the same login phrase (and hence the same decryption key) as the lost or stolen secure information storage apparatus and downloads backup encrypted confidential information from the PC. The administrator then has full access to the confidential information.

The apparatus of the Invention allows a user to review, retrieve and edit confidential information anywhere and any time without the use of a multi-tasking computer. Information stored in the apparatus is secure and the information cannot be transferred out of the invention, except in encrypted form and upon command of a person in possession of the password. The encrypted backup file transferred to a multi-tasking computer cannot be decrypted even by a person in possession of the password. The encrypted backup file could be subject to a brute force attack; however, a successful attack is highly unlikely. For example, in the case of a decryption key involving 32 fields and 100 possible symbols per field, it would take more than 10 to the power of 42 years for one thousand computers each attempting one hundred billion decryption keys each second to try every possible key.

Only if the backup file is uploaded to another secure information storage apparatus of the Invention may the file be opened, and then only by a person using the password with which the backup file was created.

### BRIEF DESCRIPTION OF THE FIGURES

FIG. 1 is a perspective view of the apparatus of the Invention.

FIG. 2 is a schematic view of the apparatus showing the relation among the components.

FIG. 3 is a circuit diagram of the apparatus.

FIGS. 4A-4C is a flow chart of the login process.

FIG. 5 is a flow chart illustrating the entry of confidential information into the apparatus.

FIG. 6 is a flow chart illustrating accessing and viewing confidential information stored in the secure information storage apparatus.

FIG. 7 is a flow chart illustrating backing up encrypted confidential information by uploading the information to a personal computer.

FIG. 8 is a flow chart illustrating retrieving back-up information by downloading the encrypted information from the personal computer.

FIG. 9A-9O is a detailed flow chart of the operation of the apparatus.

### DESCRIPTION OF AN EMBODIMENT

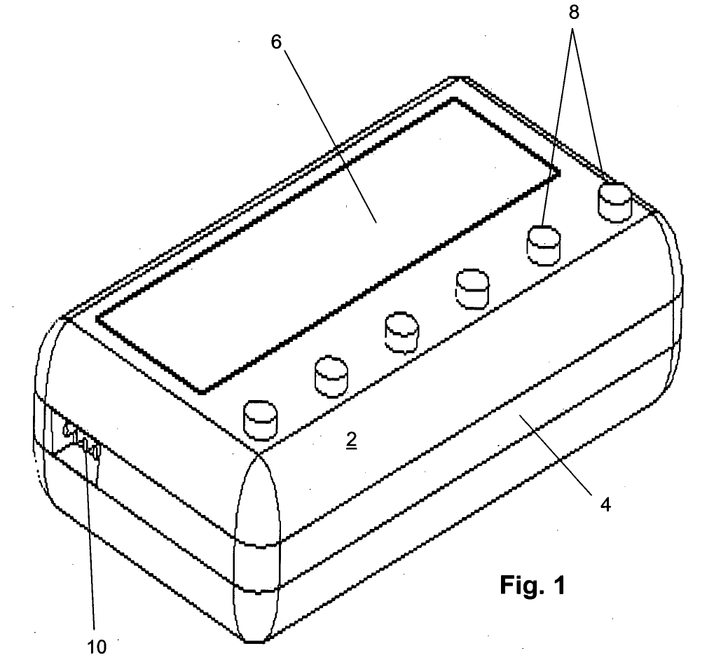

As shown by FIG. 1, the secure information storage apparatus 2 is housed in a case 4. Visible on the outer surface of case 4 are LCD screen 6, six buttons 8 and a port 10. The buttons 8, LCD screen 6 and port 10 are conventional and well known in the art.

Any port 10 may be used, provided that the port 10 is capable of communicating with a personal computer or other back-up device able to store encrypted files. A serial port 10 meeting the RS232 specification is suitable for the application.

Any suitable LCD screen 6 may be used, such as readily available LCD screens 6 capable of displaying 122×32 pixels. Such an LCD screen 6 is capable of displaying four lines of twenty characters each.

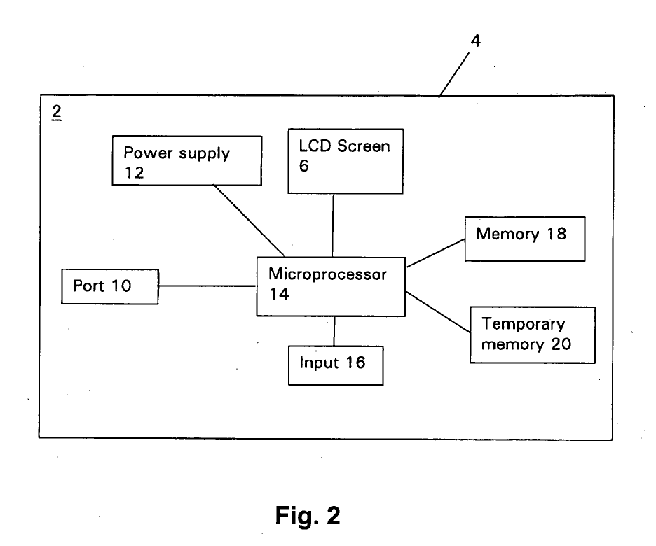

FIG. 2 is a schematic drawing showing the relationship among the components. As shown by FIG. 2, a power supply 12 powers a microprocessor 14 and associated components. The power supply 12 and microprocessor 14 are conventional. The power supply 12 is a battery, although any suitable power supply 12 may be used. Any suitable microprocessor 14 may be used. The microprocessor 14 is configured and programmed to receive information from an input 16. The input 16 comprises the six buttons 8. The microprocessor 14 is further configured and programmed to receive confidential information from user via the input 16, to encrypt the confidential information and to store the encrypted information in long term memory 18. Upon entry of a correct login phrase by user, microprocessor 14 is programmed to decrypt the confidential information stored in long term memory 18, to temporarily store the decrypted information in temporary memory 20 and to exhibit the decrypted information to user on LCD screen 6. As used in this application, the term “display” means an LCD screen 6 or any other means known in the art for exhibiting information to a user.

Long term memory 18 preferably is incorporated into the same microchip as microprocessor 14. Including long term memory 18 in the same chip with microprocessor 14 improves security by effectively preventing an invader from separating long term memory 18 from the microprocessor 14 and hence prevents an invader from thus bypassing the log-in safeguards described below.

Microprocessor 14 and memory 18 may be imbedded in a substantially rigid polymer to increase the difficulty in separating microprocessor 14 and memory 18. If an invader attempts a brute force attack by attaching memory 18 directly to a supercomputer, the invader likely will damage the memory 18 and destroy the encrypted data files.

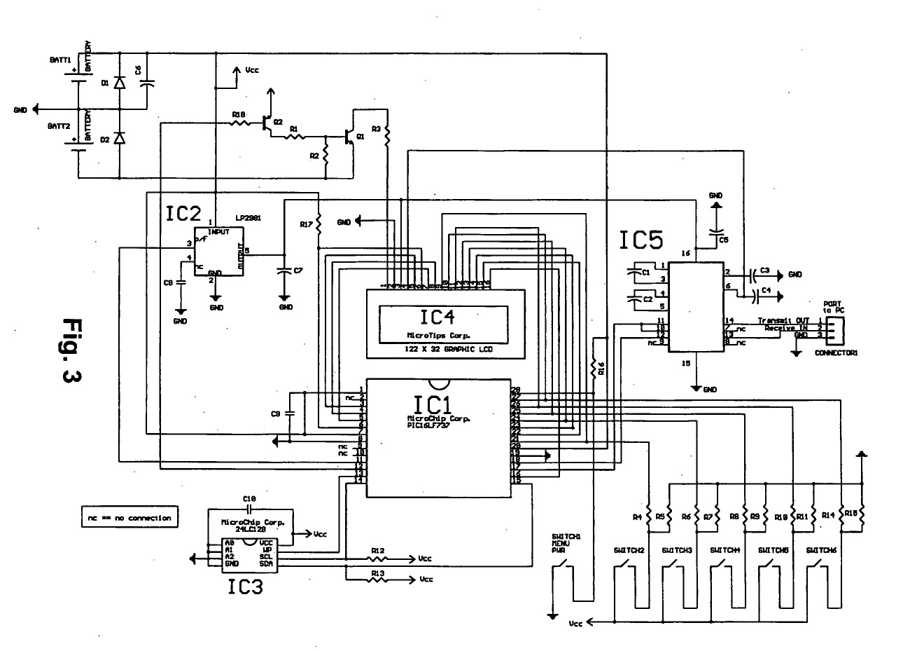

FIG. 3 is a circuit diagram of the secure information storage apparatus. The following Table 1 is a list of the components used to construct the secure information storage apparatus illustrated by the circuit diagram of FIG. 3.

TABLE 1

| | | |
|---|---|---|
| IC1 PIC16LF737-I/SO | MicroChip | Low Voltage |
| | Corporation | Microprocessor |
| IC2 LP2981IM5X-3 | National | Low Dropout Voltage |
| | Semiconductor | Regulator 3.0 VDC |
| | Corp. | |
| IC3 24LC128 | MicroChip | EEPROM Memory |
| | Corporation | |
| IC4 MTG- | Microtips Corp. | 122 × 32 |
| S12232CFYHSGY | | Graphical LCD |
| IC5 MAX232A | Maxim Integrated | TTL/CMOS to RS232 |
| | Products | Converter |
| BATT1, BATT2 CR2032 | Panasonic Corp. | 3.0 Volt Lithium |
| | | Battery |
| Q1 MMBT2222A | Fairchild | Small Signal NPN |
| | Semiconductor | Transistor |
| | Inc. | |
| Q2 MMBT3906 | Fairchild | Small Signal PNP |
| | Semiconductor | Transistor |
| | Inc. | |
| R1 260-4.7K | Xicon Industries | Carbon Film Resistor |
| | | 0.1 Watt Minumum |
| R2, R12, R13, R17, | Xicon Industries | Carbon Film Resistor |
| R18 - 260-10K | | 10K 5% 0.1 Watt |
| R3 260-200 | Xicon Industries | Carbon Film Resistor |
| | | 0.08 watt minimum |
| R4 to R11, R14, R15, | Xicon Industries | Carbon Film Resistor |
| R16 260-100K | | 0.08 watt minimum |
| C1, C2, C3, C4, C5 | Vishay/Vitamon | 0.1 uF 50 V 5% |
| VJ1206Y104JXACW1BC | Corp. | monolythic capacitor |
| C6, C7 | Mallory Corp. | 10 uF 25 VDC Tantalum |
| T491D106K025AS | | Capacitors |
| C8, C9, C10 | Vishay/Vitamon | 0.01 uF 10 V min 5% |
| VJ1206Y103JXACW1BC | Corp. | monolythic capacitor |
| SW1 to SW6 | Mountain Switch | Single-Pole-Single- |
| 101-0661 | Company | Throw Pushbutton |
| | | Switch |
| D1, D2 1N4001 | Diodes | general purpose |
| | Incorporated | silicon Diode |
| Connector1 | Kycon | 2.5 mm 3 conductor |
| ST-2550-5N | Incorporated | Jack |

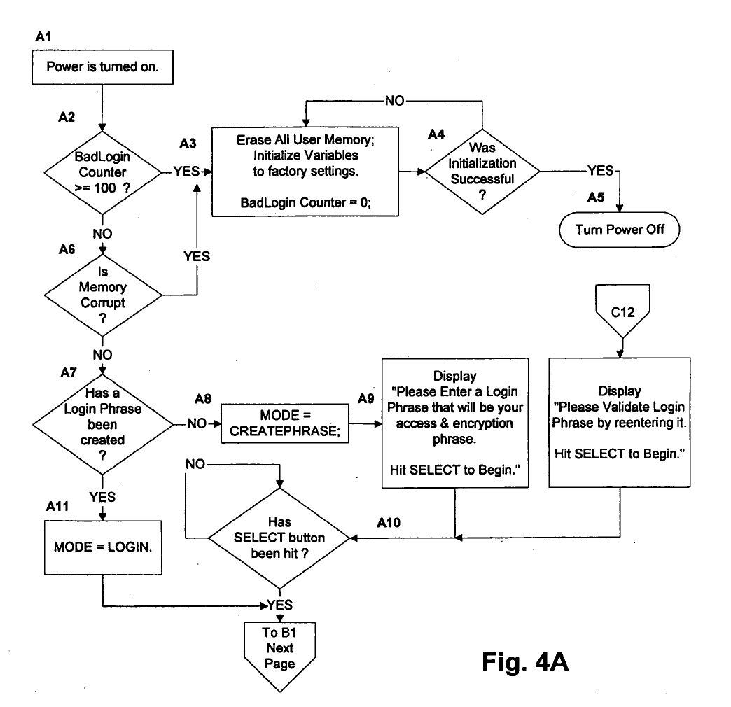

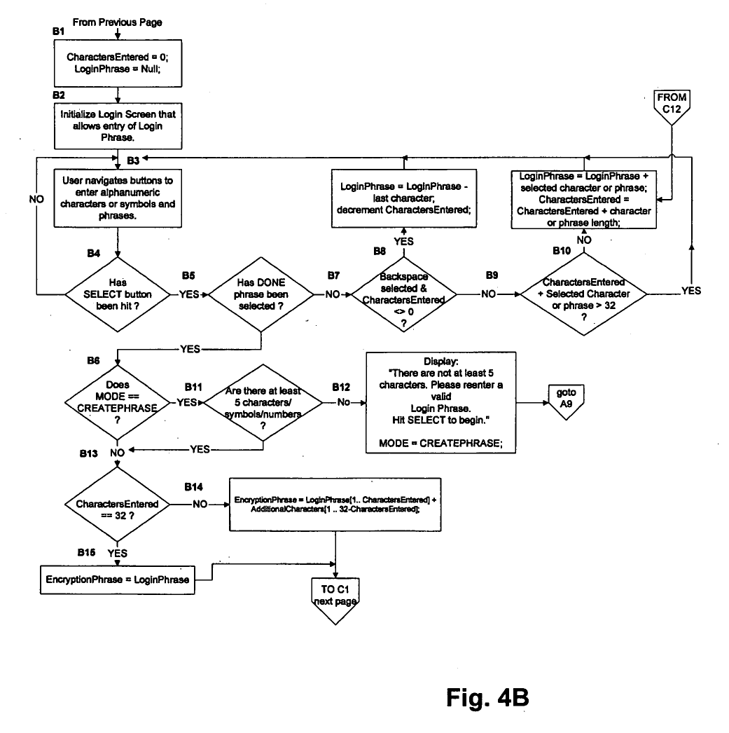

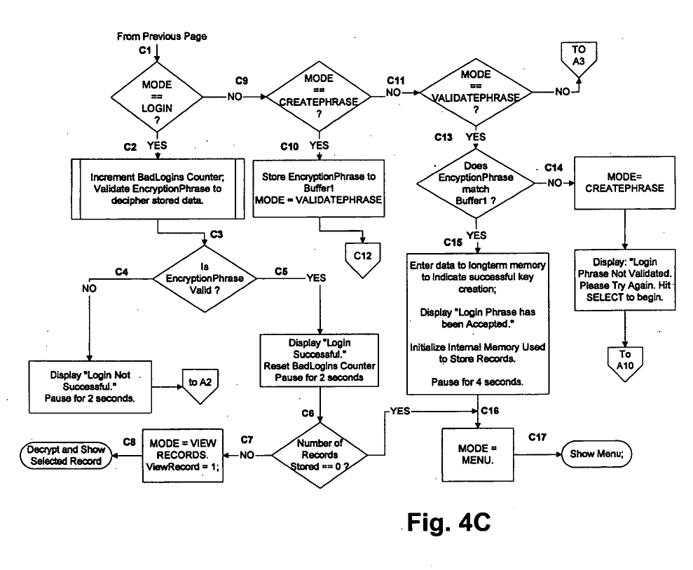

FIGS. 4A-4C illustrate the login process for the secure information storage apparatus 2. The login process illustrated by FIGS. 4A-4C is a requirement for any operation involving the secure information storage apparatus 2, including entering confidential information, viewing the confidential information, backing up the encrypted confidential information to a PC and downloading encrypted back-up data from the PC.

The following paragraphs describe the steps of the login flowchart of FIGS. 4A through 4C:

As shown by step A1, power is applied from power supply 12 to the apparatus for the first time, as by depressing a power button. Power may be applied by any means known in the art.

As shown by steps A2 and A3, the microprocessor counts each attempt to log in. If the counter records over 100 unsuccessful login attempts, the microprocessor 14 reinitializes long term memory 18, which completely erases all information stored in the long term memory 18. The purpose of automatic erasure after 100 unsuccessful login attempts is to prevent a brute force attack or multiple successive hacking attempts. A successful login resets, the number of unsuccessful logins to zero. As shown by step A4, the microprocessor 14 then checks the long term memory 18 for complete erasure and proper initialization. This step is necessary in case power is removed from the apparatus while it is in the middle of carrying out the reset sequence. The apparatus is turned off after the reset process is complete, as shown by step A5.

As shown by element A6, the microprocessor 14 determines if the long term memory 18 is corrupt. Corrupted memory 18 could result from an attempt by the apparatus to erase its long term memory 18 at the same time power is completely removed from the apparatus. If the memory 18 is corrupt, the device follows to A3 and the long term memory 18 is reinitialized and erased. If the memory 18 is not corrupt, the process continues to A7.

From element A7, the microprocessor 14 determines from long term memory 18 whether a Login Phrase had been created. As shown by elements A8 through A10, in the case that a Login Phrase had never been created, the MODE Variable is set to ‘CREATEPHRASE’ which represents a number. This will distinguish the process of logging in using an already created Login Phrase from the process of creating a new Login Phrase, as well as other processes not shown here, such as changing a Login Phrase.

As shown by element A11, if a Login Phrase had been created, the MODE variable is set to ‘LOGIN’ which represents a number. This will distinguish the login process from other processes that share common software.

Elements B1 and B2 illustrate that variables are initialized and the login screen displayed to the user on the liquid crystal display. As shown by steps B3 and B4, the user navigates through characters, numbers, symbols and phrases on the liquid crystal display using the buttons. The SELECT button selects the highlighted item on the display. Depressing the SELECT button during the login process as shown by steps B5 and B6 exits the process and allows the software to process the data entered depending on the MODE.

From steps B7, B8 and B3, if the DONE phrase is not selected and if characters have been entered and BACKSPACE is selected, the last character is removed from the Login Phrase. The number of characters in the User Phrase is also decremented by one. The embodiment illustrated by FIGS. 4A-4C addresses an encryption algorithm that utilizes a decryption key of 32 symbols in length. Decryption keys of any suitable length may be selected, consistent with the requirements of the selected encryption algorithm.

From steps B9, B10 and B3, if DONE and BACKSPACE were not selected and the number of characters in the Login Phrase plus the addition of the selected text results in an updated Login Phrase of length less than 33 symbols in length, the character, number, symbol or phrase is added to the variable ‘Login Phrase’. Examples of phrases could be ‘www.’, which adds a length of four to the Login Phrase. As shown by steps B9 and B3, in the event the Login Phrase with the addition of the newly selected text would result in a User Phrase of length greater than 32, nothing is done to the Login Phrase. The microprocessor 14 therefore will not allow symbols to be added to a Login Phrase that is more than 32 symbols in length.

From steps B6, B11, B12 and A9, if the MODE is CREATEPHRASE and DONE is selected, the microprocessor 14 will determine whether the proposed Login Phrase has at least five symbols. The microprocessor 14 will not allow the user to create a Login Phrase that is less than five symbols in length. If the selected Login Phrase has less than five symbols, the user is notified of this fact and given another opportunity to reenter a valid Login Phrase. The apparatus will require at least five symbols from a field of, say, 100 possible symbols to increase the likelihood that an invader will not guess the Login Phrase.

From steps B6, B13 and B14, once the Login Phrase is valid, if the number of symbols in the Login Phrase is less than 32, a number of symbols is added to the Login Phrase to bring the length to 32 symbols. This extended phrase of 32 symbols is called the EncryptionPhrase. The EncryptionPhrase is also referred to in this application as the “decryption key.” The number of symbols in the EncryptionPhrase is selected to be consistent with the decipher/encryption algorithm and may be more or less than 32. The addition of symbols to the selected Login Phrase to bring the total number of symbols to 32 (or some other value consistent with the encryption algorithm) is referred to in this application as the “concatenation protocol.” From steps B13 and B15, if the number of characters in the Login Phrase is 32 (or other number consistent with the decipher/encryption algorithm) then the EncryptionPhrase is the Login Phrase.

As shown by steps C1 through C4 and A2, the LOGIN MODE is used to gain access to the long term memory of the apparatus. If the MODE is LOGIN, the microprocessor 14 will attempt to decipher encrypted data, such as the user name, stored in long term memory 18 using the EncryptionPhrase and to match the decrypted data to unencrypted data such as a stored checksum. If the microprocessor 14 is successful, then the EncryptionPhrase is valid. If the microprocessor 14 is not successful in decrypting the user data using the sequence of symbols input by the user, then the microprocessor 14 concludes that the sequence of symbols is not the correct EncryptionPhrase and the number of bad logins is incremented by one. The microprocessor 14 then allows the user to attempt to log in again.

From steps C1 through C8 and C16 and C17, if the MODE is LOGIN, an attempt to decipher the user data is being made. If the EncryptionPhrase can successfully decipher stored data, then the EncryptionPhrase is valid. When the login is successful, if no records are stored in the long term memory 18, the MODE is set to MENU which displays the MENU of options to the user. If at least one record is stored after a successful login, the MODE is set to VIEW RECORDS, which then displays a previously entered record.

As illustrated by steps C1, C9, C10 and C12, if after entering a Login Phrase, the MODE is CREATEPHRASE, the EncryptionPhrase is stored to temporary memory 20 to allow the user to reenter the same Login Phrase to validate it. As shown by steps C1, C9, C11, C13, C14 and A9, if after entering a Login Phrase, the MODE is VALIDATEPHRASE and if the entered EncryptionPhrase does not match the previously entered EncryptionPhrase, the MODE is set again to CREATEPHRASE and the user is given the opportunity to create a successful Login Phrase.

From steps C1, C9, C11, C13, C15, C16 and C17, if after entering a Login Phrase, the MODE is VALIDATEPHRASE and the current and previous EncryptionPhrases match, the user is notified of a successful Login Phrase, long term memory 18 is Initialized and the MODE is set to MENU since no records could be available to be viewed.

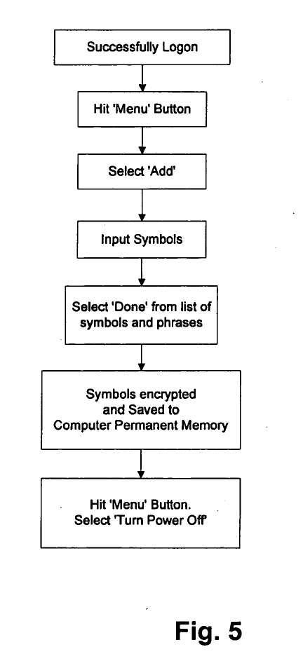

FIG. 5 illustrates creation of a user-selectable data file by entering of confidential information into the secure information storage apparatus 2 after login. After login, the user presses a button 8 assigned as the “menu” button. The user is presented with a menu of choices. The user selects ‘Add’ from the menu. The microprocessor 14 presents the user with a menu of symbols from which to select. The user selects symbols in sequence using buttons 8 until the entire sequence of symbols in the password, account number or other item of confidential information is complete. The user then selects ‘Done.’ The microprocessor 14 then encrypts the item using the encryption algorithm and saves the resulting data file to long term memory 18.

If an item of confidential information becomes obsolete and of no further use, the user may select the item and select ‘delete,’ removing the item from long term memory 18.

When the user no longer requires access to the secure information storage apparatus 2, the user will depress a button 8 assigned to the ‘menu’ function. The user then selects ‘turn power off’ from the choices presented by the menu. The microprocessor 14 then turns off the secure information storage apparatus 2, erasing the decrypted information from temporary memory 20 and leaving intact the encrypted information in long term memory 18. Any suitable power-off triggers may be selected, such as a timer that automatically turns off the secure information storage apparatus 2 after the passage of a pre-determined period of time. As used in this application, “means for deactivating the apparatus” includes selection of ‘turn power off’ as described above and all other power-off triggers known in the art, including use of a timer.

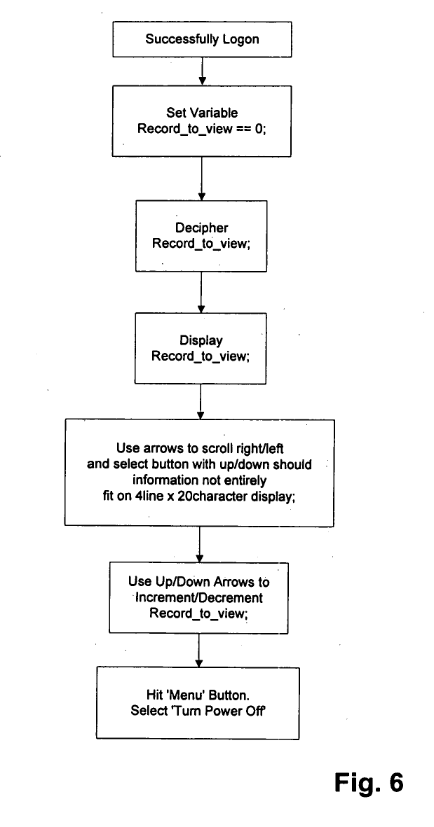

FIG. 6 is a flow chart illustrating the viewing of confidential information using the secure information storage apparatus 2. The user goes through the login process described above relating to FIG. 4. Upon successful login and if an item of confidential information has been encrypted to the long term memory 18 of the apparatus, the microprocessor 14 sets the variable ‘record to view’ at zero. The microprocessor 14 uses the decryption key to decrypt the item of confidential information corresponding to the zero value of the variable ‘record to view.’ The microprocessor 14 stores the decrypted confidential information in temporary memory 20. The LCD screen 6 displays the first item of confidential information corresponding to the ‘zero’ value of the variable ‘record to view.’

If the entire record is not visible on the 4 line by 20 character LCD screen at one time, the user will use the buttons 8 assigned to arrow functions to scroll the image left and right. The user will use the up and down arrow keys to step incrementally through other items of confidential information encrypted in the apparatus memory.

When the user is finished using the confidential information, the user depresses the ‘menu’ button and selects ‘power off’ from the menu choices. The secure information storage apparatus then powers off. As described above, the decrypted information in temporary memory 20 is erased, leaving the encrypted information in long term memory 18.

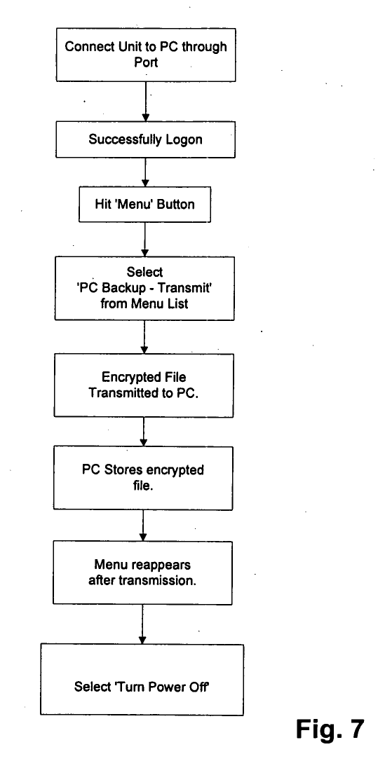

FIG. 7 illustrates backing up of encrypted confidential information to a PC. The secure information storage apparatus 2 is connected to a PC or other back-up device using the port 10. The user goes through the login process described above relating to FIG. 4. The user depresses the button 8 assigned to the ‘menu’ function. The user selects ‘PC Backup—Transmit’ from the options presented. The microprocessor 14 causes the encrypted confidential information files to be delivered to the port 10. The items of confidential information are delivered to the port 10 only in encrypted form.

The PC receives the encrypted confidential information and stores the encrypted confidential information in the PC memory. The user selects a PC having a security environment consistent with the need for confidentiality of the confidential information. While the data on the memory of the PC is encrypted, the information is at some risk from a brute force attack if the encrypted confidential information is stolen from the PC.

When the transmission to the PC is complete, the LCD screen 6 displays the ‘menu.’ If the user is finished using the secure information storage apparatus 2, the user selects “turn power off’ from the menu, powering off the apparatus.

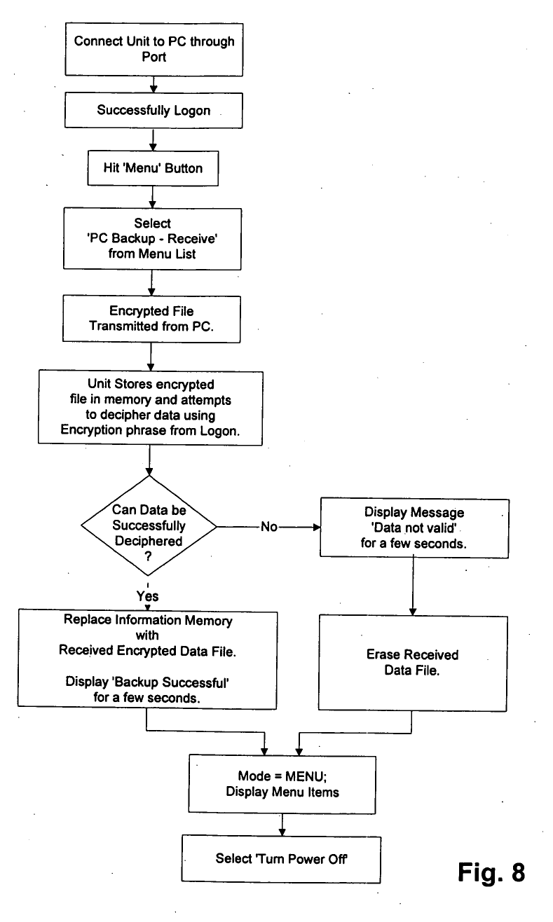

FIG. 8 is a flowchart illustrating the process of importing backup confidential information from PC memory. As shown by FIG. 8, the user first connects the secure information storage apparatus 2 to the PC through the port 10. The user then follows the login procedures described above and illustrated by FIG. 4. The user depresses the button assigned to the ‘menu function. The user selects “PC Backup—Receive” from the options presented by the menu displayed on the LCD screen 6. The PC copies the encrypted confidential information file in PC memory and delivers the file to the port 10. The secure information storage apparatus 2 reads the encrypted file and attempts to decrypt the file using the decryption key.

If the decryption is successful, the microprocessor 14 concludes that the file is valid and saves the file to long term memory 18 in encrypted form, replacing files in the existing encrypted long term memory 18 with the received data file. The LCD screen 6 displays “backup successful” for a few seconds.

If the microprocessor 14 is not successful in decrypting the received data files using the decryption key, the microprocessor 14 concludes that the files are not valid and deletes the received files from temporary memory 20. When the user is finished retrieving the backup files, the user turns off the power to the secure information storage apparatus 2 as described above.

A number of alternate embodiments of the invention are possible. The case 4 may be the case 4 of a personal digital assistant (“PDA”), palmtop computer or any other portable device. The apparatus of the invention, including microprocessor 14, long term memory 18 and temporary memory 20, may exist separately within the PDA or palmtop computer case 4, side-by-side with the PDA or palmtop computer apparatus. The reason for using a separate microprocessor 14 and long term memory 18 for the secure information storage apparatus 2 is to prevent a hacker from gaining access to the confidential information by compromising the PDA or palmtop computer. PDAs, palmtop computers and PCs are capable of multitasking (running more than one program at the same time) and hence are vulnerable to malicious software designed to steal data. For lower security environments, the Invention may be accomplished by a software application resident within a general purpose computer, such as a PDA or palmtop computer so long as deciphered user information may not exit any port or written or stored media from the device.

As another alternative, long term memory 18 may be divided into a plurality of memory areas using techniques familiar in the art. Each of the memory areas may be used to separately store confidential information encrypted using a different decryption key than the decryption keys used for other memory areas. The same secure information storage apparatus 2 may then be used by a plurality of persons with complete security, since each person would have access only to the confidential information encrypted with the decryption key known to that person.

The use of multiple memory areas also minimizes the damage caused by the theft of a secure information storage apparatus 2 while the apparatus 2 is in use and the user logged on. In such an event, the thief would have access to the memory area to which the user was logged on, but would not have access to the remainder of the encrypted confidential information stored in the other memory areas.

An extra security precaution is provided by embedding the microprocessor 14 and its leads in hardened epoxy resin. An invader likely will not attempt a brute force attack through use of the buttons 8 and LCD display 6 of the secure information storage apparatus 2. Instead, the invader will attempt to remove the microprocessor 14 from the case 4 and attach the microprocessor 14 directly to another computer, such as a supercomputer. Any attempt to remove the epoxy-embedded microprocessor 14 or to disconnect its leads likely will damage the microprocessor 14. The microprocessor 14 also houses the long term memory 18. Damage to the microprocessor 14 likely will destroy the encrypted confidential information stored in long term memory 18 or render the encrypted confidential information inaccessible.

The Invention can incorporate cryptographic algorithms in software or use secure memory devices, such as Atmel Corporation's CryptoMemory® devices to accomplish the task of encrypting sensitive information for non-volatile memory storage.

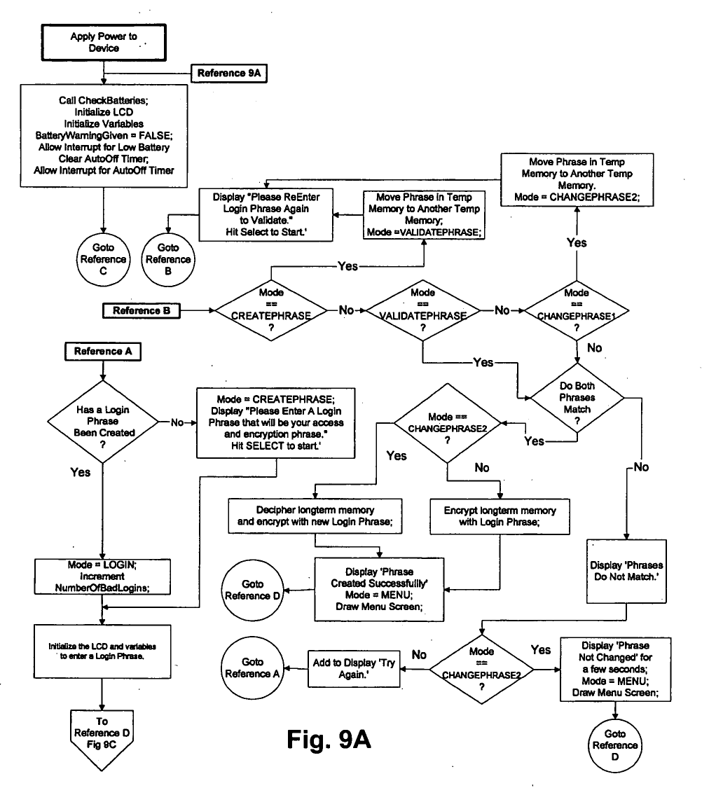

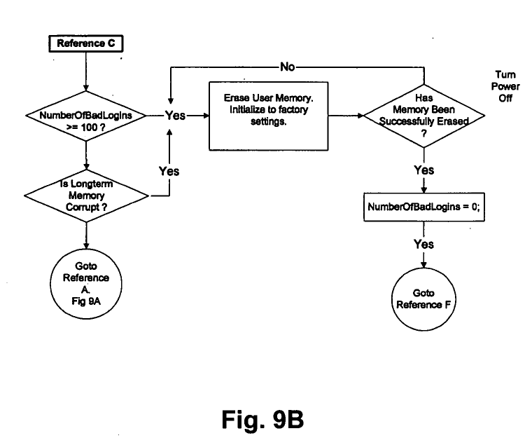

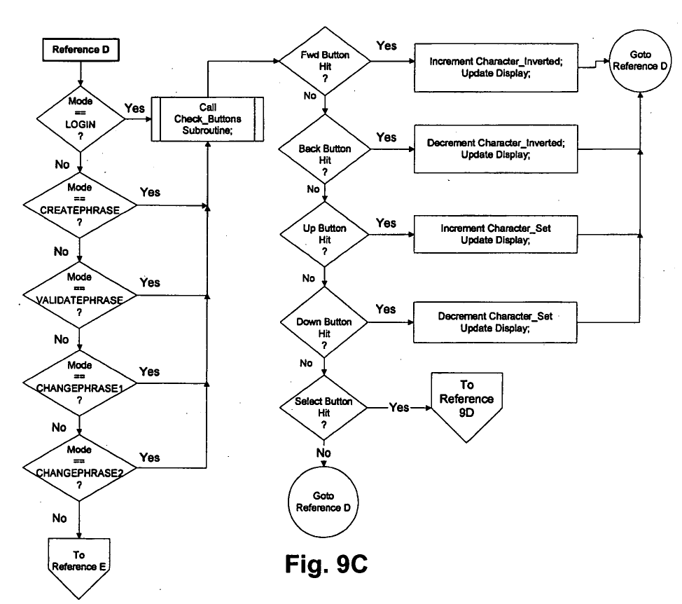

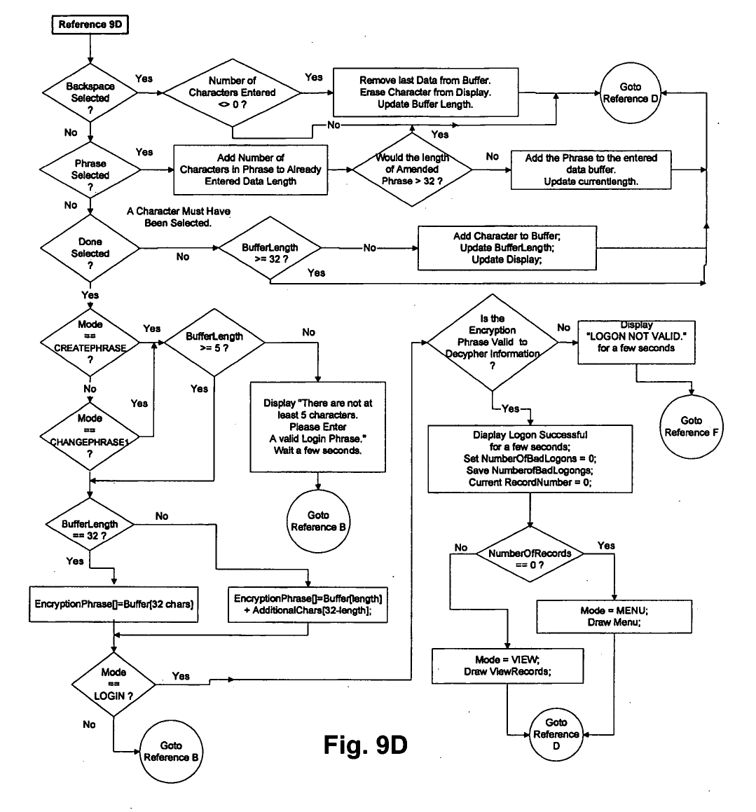

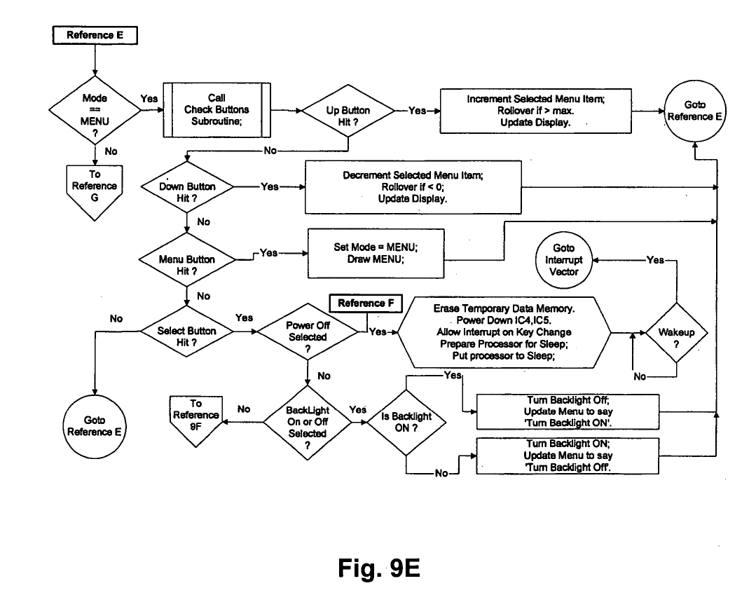

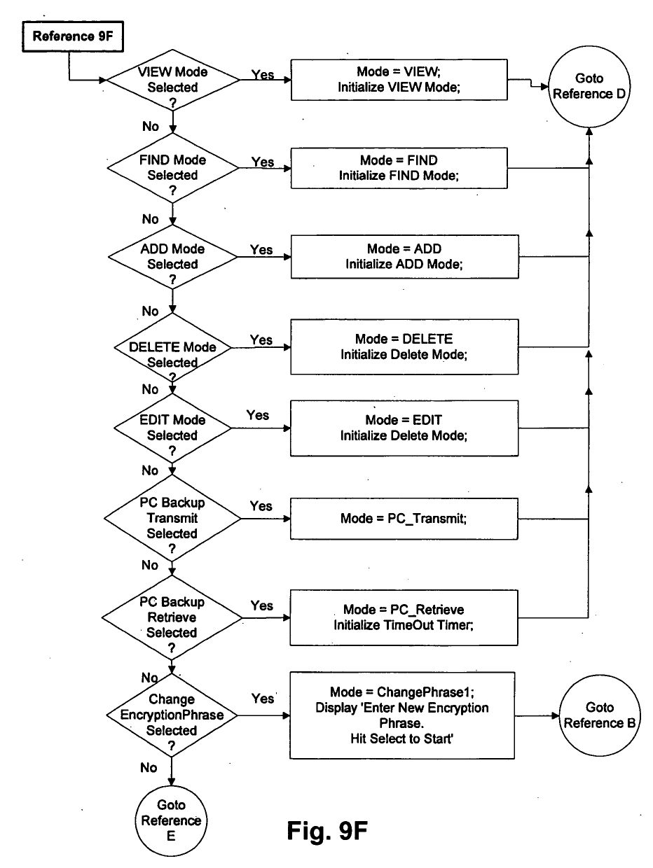

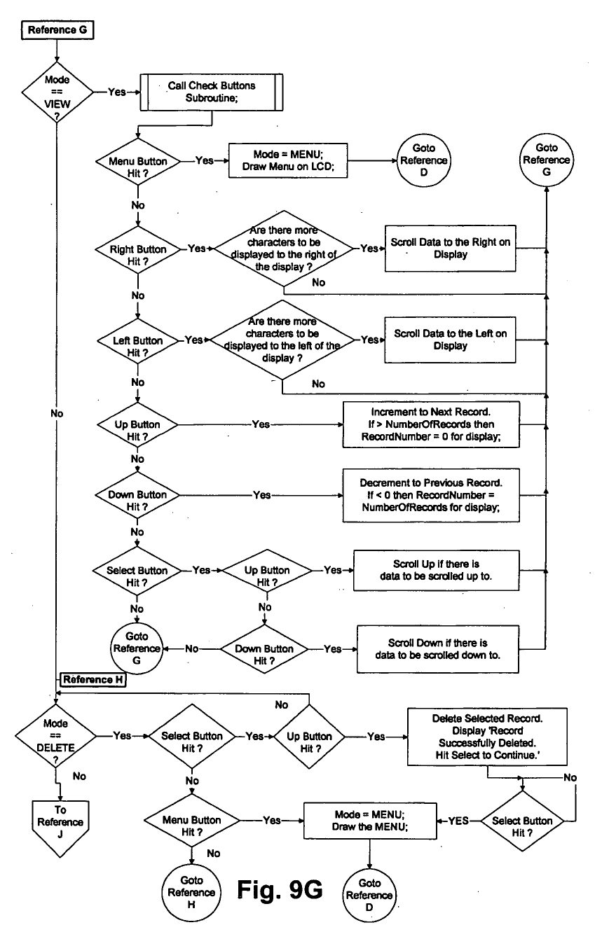

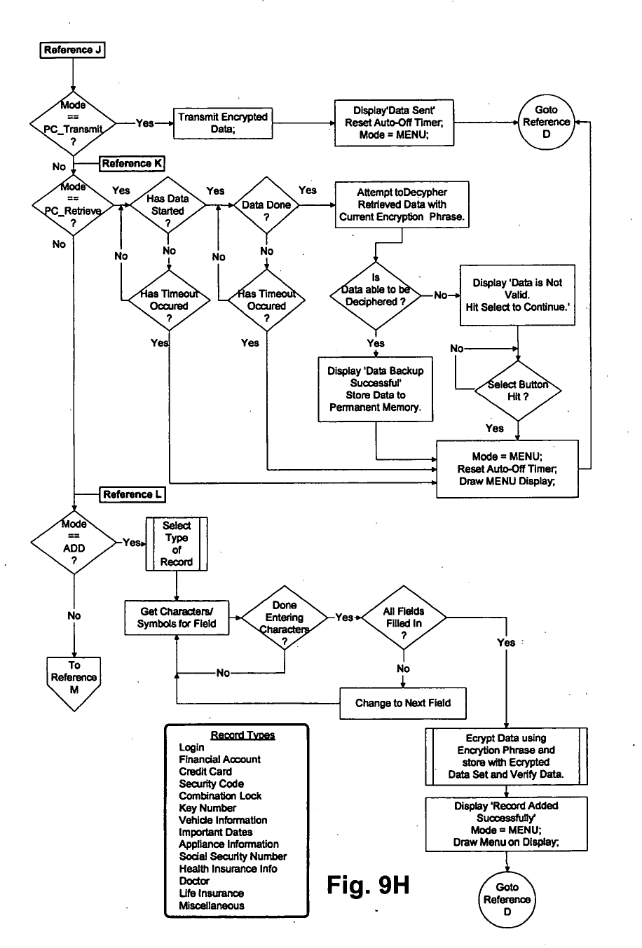

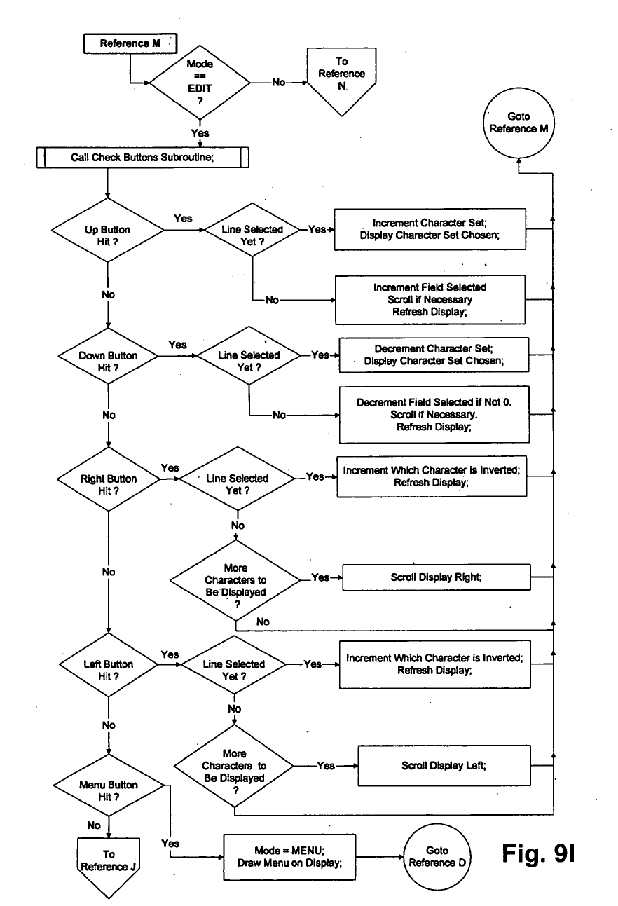

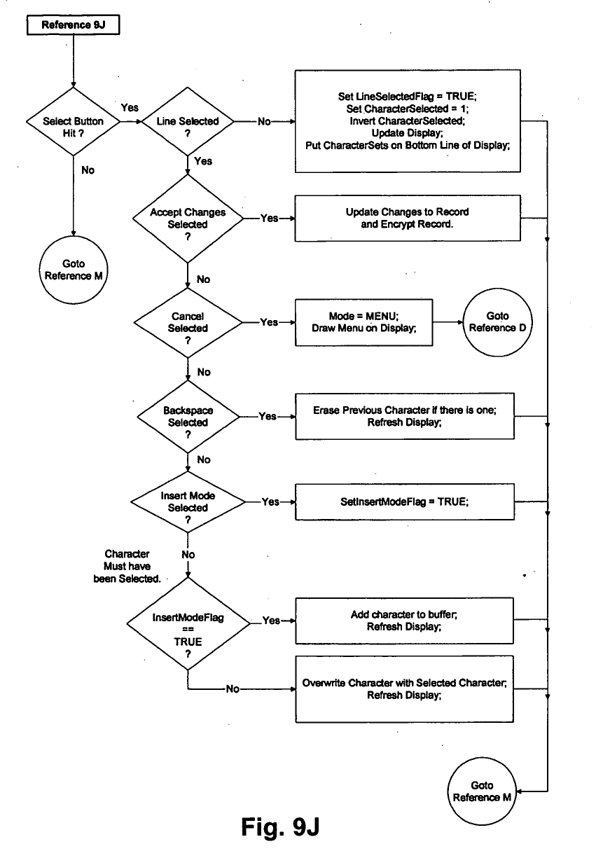

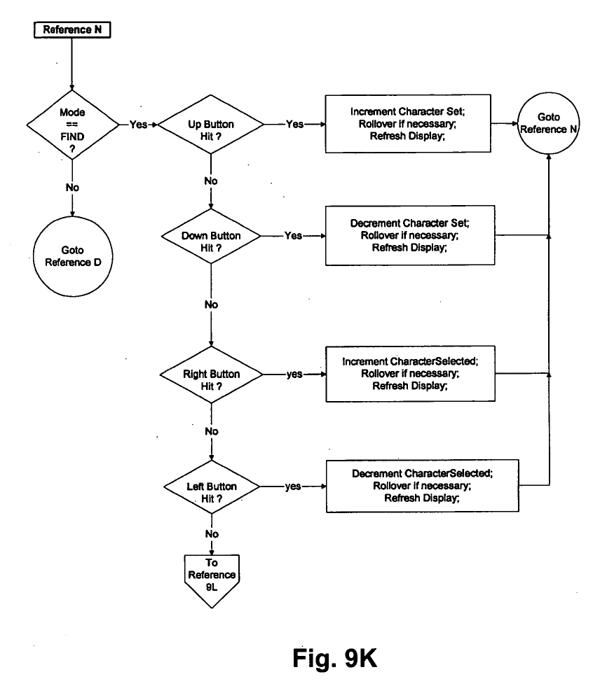

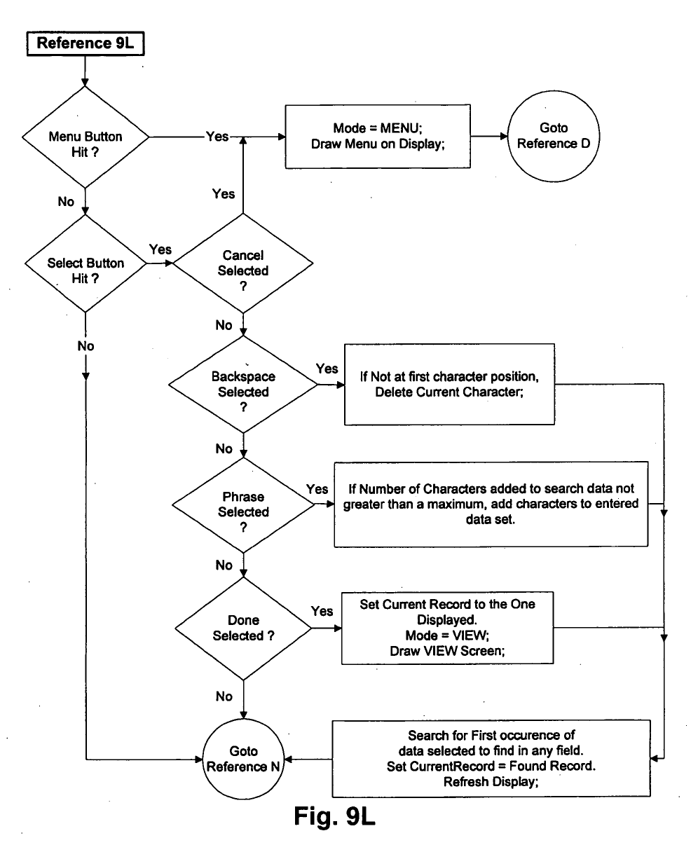

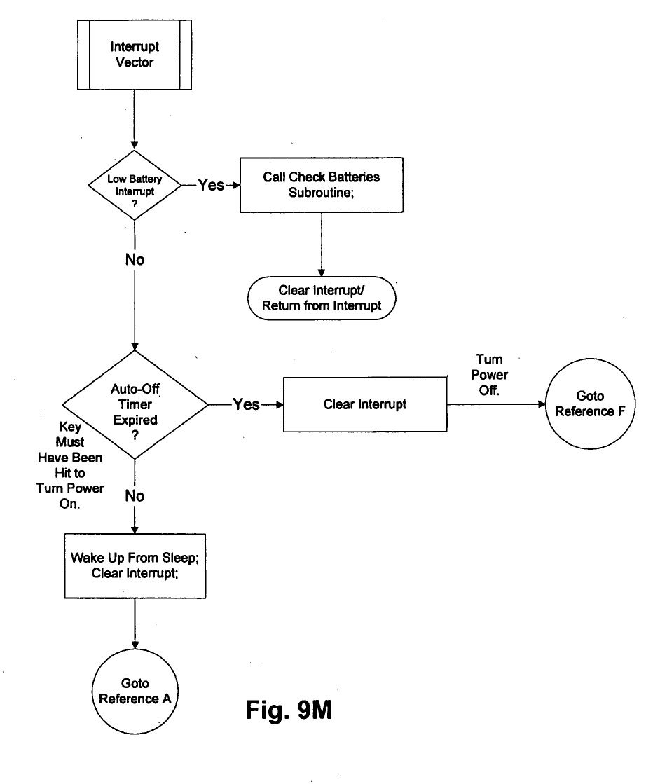

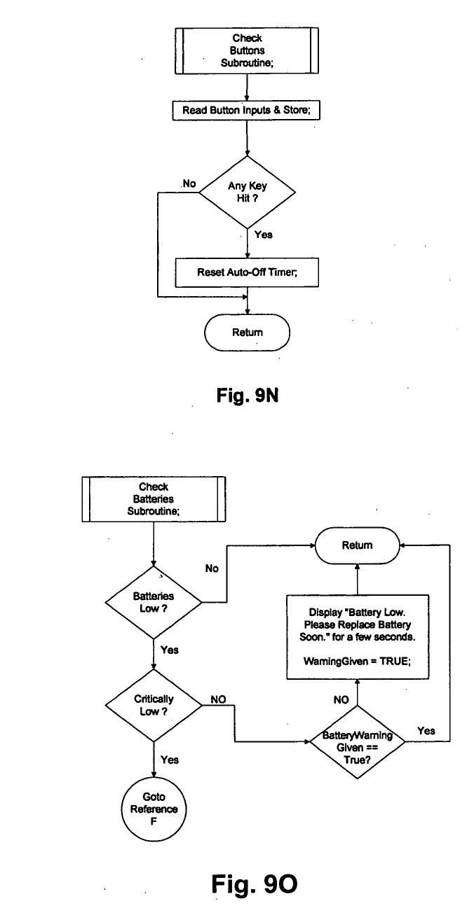

FIGS. 9A-9O, consisting of fourteen sheets, comprises a single detailed flowchart of the operation of the secure information storage apparatus. FIGS. 9A-9L describe the operation of the thirteen major portions of that operation, denominated as References A-N (no Reference I is included on FIGS. 9A-9N). FIG. 9M illustrates an interrupt vector. FIGS. 9N and 90 show subroutines referred to in FIGS. 9A-9L. The following paragraphs are a narrative description of the flowchart of FIGS. 9A-9O, including References A-N, the interrupt vector of FIG. 9M and the subroutines of FIGS. 9N-O.

First, power is applied to the device, as shown by FIG. 9A.

Powering the Device to Reference C

Power is applied to the device. Reference 9A, shown by FIG. 9A, describes initialization of the apparatus. Interrupts are also enabled so that when battery voltage falls below a threshold the device may notify the user and take appropriate actions. A watchdog timer interrupt is also enabled. The purpose of the watchdog is to automatically turn the unit off after some preprogrammed amount of time during which no buttons have been depressed. Interrupts allow a microprocessor, when enabled, to stop execution of sequential programming code to process some process that requires immediate attention like that of a low battery or inactivity.

Reference C to Reference F

Reference C, shown by FIG. 9b, illustrates the security feature of memory erasure to protect the apparatus from a brute force attack. If the number of incorrect sequential logins is greater or equal to one-hundred, the information in long term memory 18 is erased. Once the long term memory 18 is erased, the power is turned off. This puts the apparatus in its original state before power was ever applied to the secure information storage apparatus 2 for the first time. When the memory has been successfully erased, the number NumberOfBadLogins variable will be reset to zero and the unit will turn off.

When the NumberOfBadLogins is less than one hundred but the long-term memory 18 is determined to be corrupt, the erase and reset procedure is executed as above until power is turned off.

The process of determining if the long-term memory 18 was successfully reset before resetting the variable NumberOfBadLogins is necessary for the instance where power could be removed from the device before the reset process is finished. In the case where the power is removed before the reset process is done, the NumberOfBadLogins is maintained at one hundred or greater, insuring that when the unit is powered again, this reset process starts over.

Reference C to Reference A

If the variable NumberOfBadLogins is less than one hundred and the long-term memory 18 is not corrupt, execution of the program proceeds to Reference A.

Reference A to Reference D

Reference A determines if an encryption phrase had been previously created by recalling data stored in permanent long term memory 18. If an encryption phrase had not previously been created, the mode variable will be set to CREATEPHRASE which represents a number.

For the case where a Login phrase had been created, the variable mode will be initialized as LOGIN. This mode represents the process where a user logs into the device to gain access to stored long-term memory 18. Also, the NumberOfBadLogins will be pre-incremented before the login phrase has been entered. The NumberOfBadLogins is pre-incremented under the assumption that the attempt to login to the device will be a failure and in the event that power is immediately removed from the device after a failed login, there will be no failure to increment the NumberOfBadLogins variable.

The use of the variable mode is necessary so that common programming code can process a login phrase for multiple purposes. For example, a standard Login, creation of a Login Phrase and changing the Login Phrase after one had been in place.

The LCD is then initialized for the Login Phrase entry process.

Reference D

Reference D, shown on FIGS. 9C and 9D, describes entry of the Login phrase, as when the apparatus is turned on by a user for the first time, or when validating the same, or when changing a previously created login phrase or when validating the same. The logic is configured to allow the Login phrase data to be used either as a standard Login phrase or for creating and validating a Login phrase and also for changing and validating the changing of a Login phrase.

If the Mode is LOGIN, CREATEPHRASE, VALIDATEPHRASE, CHANGEPHRASE1, or CHANGEPHRASE2 the buttons are processed for the purposes of selecting characters, symbols, and/or numbers to be used for the Login Phrase.

In the Login Mode, an encryption/decipher phrase is keyed into the apparatus using buttons 8. A menu of characters is presented to the user on the bottom of the LCD screen 6. Each of the buttons 8 of the apparatus is assigned a function for navigating through the choices presented by the LCD screen 6 and selecting a choice. One character or series of characters of the character set is displayed as inverted. The term “inverted” means that the symbol/field relationship is reversed so that if the symbol is dark and the background light, the background becomes dark and the symbol becomes light. The inverted character or phrase is the character or phrase selected when the Select Button is depressed. Different character sets are chosen by using the up and down pointing arrows. Characters or phrases are chosen by using the right and left pointing arrows. Once all characters are keyed in that make up the user's encryption/decipher phrase, the phrase ‘Done’ is selected from the character sets.

If a button 8 is hit then the timer used to automatically turn-off the apparatus is reset.

If the Right pointing arrow (Fwd Button) is hit, the next character to the right is inverted. The display is then updated. If the next character to the right does not exist, then the next character inverted is the first character of the character set on the left of the display. If the next character is part of a phrase, the entire phrase is inverted. For example, if ‘d’ of the phrase ‘done’ is the next character to be selected, the entire phrase ‘done’ will be selected.

If the left pointing arrow (Back Button) is hit, the next character to the left is inverted. The display is then updated. If the next character to the left does not exist, then the character to the right of the display in the character set is inverted. If the next character is part of a phrase, the entire phrase is inverted. For example, if ‘d’ of the phrase ‘done’ is the next character to be selected, the entire phrase ‘done’ will be selected.

If the Up Button is hit, the next character set is displayed with the same character position inverted as from the last character set. If the new inverted character is part of a phrase, the entire phrase is inverted.

If the Down Button is hit, the previous character set is displayed with the same character position inverted as from the last character set. If the new inverted character is part of a phrase, the entire phrase is inverted.

‘Select’ is used to select the inverted character or phrase. If the inverted phrase is ‘bspc’ (backspace) and the number of previously entered characters is greater than 1, then the most recently entered data is erased from the LCD screen 6 and the cursor is move to the previously entered character. If a phrase other than ‘bspc’ and other than ‘done’ is selected, the entire phrase is added to the encryption decipher phrase.

Once ‘done’ is selected and the mode is either CREATEPHRASE or CHANGEPHRASE, the apparatus checks to make sure five or more characters/symbols/numbers were used to create the Login Phrase. For the case where there were less than five characters/symbols/numbers, another opportunity is given to enter a correct Login Phrase.

The number of characters entered as the Login Phrase is then compared to 32. When less than 32 characters have been entered as the Login Phrase, a number of characters are added to the user Login phrase so that the length of the both is 32. If the length of the user Login phrase is 32, the encryption phrase is the user entered Login Phrase.

If the mode is LOGIN, the Encryption phrase is used to decipher the user long term memory 18. When known data can be extracted from the users long term encrypted memory, such as a checksum embedded in the data, the encryption phrase is validated and if records have been previously stored, the first record is deciphered and displayed on the LCD. If no records had been previously stored, the device's menu is displayed on the LCD.

When a Login Phrase is being created or a Login Phrase is being changed, logic if passed onto Reference B.

Reference B

Reference B of FIG. 9A processes the creation of a Login phrase as well as changing a Login Phrase once a Login Phrase had been created.

When the mode is CREATEPHRASE and a Login Phrase has already been entered, the Mode is changed to VALIDATEPHRASE and the user is given a message to reenter the login phrase to validate.

If the Login Phrase entered during the mode CREATEPHRASE matches the Login Phrase entered during the VALIDATEPHRASE mode, the user is told that the Login Phrase was created successfully. Long term user memory will now be encrypted according to this Login Phrase as it is used to create the encryption phrase.

When the Login Phrase entered during the mode CHANGEPHRASE1 matches the Login Phrase entered during the mode CREATEPHRASE2, the Login phrase will be successfully changed and the user will be notified of this.

When Login phrase doesn't match during the CREATEPHRASE and VALIDATEPHRASE, the user is notified and given another opportunity to create a Login Phrase.

When Login phrase doesn't match during the CHANGEPHRASE1 and CHANGEPHRASE1 modes, the user is given notice “Phrase Not Changed” and no change to the LOGINPHRASE is performed.

When a change to the Login Phrase is requested, data is deciphered with the old login phrase and then encrypted with the new login phrase. Once this process is complete, changing of the Login Phrase is successful.

References E and F

References E and F on FIGS. 9E and 9F describe the Menu Mode. The apparatus will first determine whether it is in Menu Mode. If the apparatus is in Menu Mode, the user can select from the following options: Turn Power Off, Turn Backlight On/Off, View (Records), Add (Records), Delete (Records), Edit (Records), Find (Records), PC Backup-Transmit, PC Backup-Retrieve, and Change Encryption Phrase. Those commands are as follows:

Turn Power Off—powers off the apparatus.

Turn Backlight On/Off. If the Backlight is off, the menu will display ‘Turn Backlight On’. The opposite is true is the Backlight is on.

View Mode will allow the user to view records that have been previously entered. In the VIEW mode, using the up and down arrow buttons will move to the previous and next stored records. Using the Select Button simultaneously with the up and down arrow buttons will allow the user to scroll the data up and down on the display. The right and left pointing arrow buttons will allow the user to scroll the data right and left on the display.

Add Mode will allow the user to select from the following categories:
Login
Financial Account
Credit Card
Security Code
Health Insurance
Doctor
Life Insurance
Vehicle Information
Social Security Number
Appliance

Combination Lock
Key Number
Important Dates
Miscellaneous

Each of these categories will provide for a title or description to be input along with the fields associated with each category. The categories, along with each category's associated fields, are:

Login
Description/Title
Username
Password
Customer Service Phone Number
Note

Financial Account
Description/Title
Account Number
Bank Card Number
Bank Card Expiration
Personal Identification Number (PIN) Number
Web Login
Password
Customer Service Phone Number
Note

Credit Card
Description/Title
Account Number
Bank Card Number
Bank Card Expiration
Web Login
Password
Customer Service Phone Number
Note

Security Code
Description/Title
Security Code
Customer Service Phone Number
Note

Health Insurance Information
Description/Title
Insurance Company
ID Number
Group Number
BIN#
Phone Number
Address
Primary Doctor
CoPay Doc
CoPay Rx
Note

Doctor
Doctor Name
Specialty
Phone
Address
City
State
Zip
Note

Life Insurance
Company
Policy Number
Phone
Note

Vehicle Information
Make
Model
Year
VIN
License#
Odometer
Buy Price
Insurance Company
Policy#
Note

Social Security Number
Exact Name
SSN
Birthday
Note

Appliance Information
Title
Manufacturer
Model
Serial Number
Buy Date
Warranty Length
Buy Price
Note

Combination Lock
Description/Title
Combination

Key Number
Description/Title
Key Number

Important Dates
Description/Title
Who
Date
Occasion
Note

Miscellaneous
Line1
Line2
Line3
Line4

The Find Mode will provide a method of locating records from search criteria.

The Edit Mode provides a method for selecting records and fields from within a record for editing. Editing allows the user to alter information previously entered and stored into the apparatus.

The Delete Mode will provide a method for deleting records previously entered.

The PC Backup-Transmit provides a method for sending only the encrypted data from the apparatus to a PC through the port.

The PC Backup-Receive provides a method of receiving an encrypted file from a PC, validating it, and if the data is valid for the encryption/decipher phrase entering into the apparatus at login, the data is stored into permanent memory. If the file received from the PC is not valid for the encryption/decipher phrase entered on the apparatus, the data is erased.

The Change Encryption Phrase provides a method of changing the login encryption/decipher phrase.

Along with the above menu selections, the Microcomputer was chosen for its low operating power consumption allowing the apparatus to use batteries for an extended period of time. The Microcomputer was also chosen for its ability to detect a low battery. If this function was not available in the Microcomputer it could have been designed discretely from widely available components.

Reference G

Reference G, on page 9G illustrates the View Mode. The apparatus first determines whether it is in View Mode. If the Apparatus is in the VIEW Mode, the Record Show on the Display (record is a category of information) can be scrolled left to right using the left and right pointing arrows. Using the select button simultaneously with the up and down pointing arrowed buttons will allow scrolling of the information data up and down. Using the up and down pointing arrows will choose the next or previous record in memory. When a record is recalled from memory it is found by deciphering a block of data and determining which data is related to the record desired to be viewed. Hitting the MENU button during the View Mode will change the mode to Menu.

Reference H (Please Note that there is no Reference I),

Reference H, appearing on FIG. 9G, addresses the Delete Mode. The apparatus first determines whether it is in Delete Mode. If the apparatus is in Delete Mode, the record number that was last viewed is the selected record to be deleted. The user will be shown some of the record to be deleted and asked to hit the select button followed by the up button. This sequence validates the desire to delete the current record number. Upon a successful or unsuccessful delete sequence, the Mode will return to the Menu Mode.

Reference J

Reference J, appearing on FIG. 9H, addresses the PC Backup—Transmit Mode. The apparatus first determines whether it is in the PC Backup—Transmit Mode. If the Apparatus is in the PC Backup-Transmit Mode, the encrypted information set will be transmitted out of the apparatus's pc port. After transmission or after a time-out, the Mode will be set to the Menu Mode.

Reference K

Reference K, appearing on FIG. 9H, addresses the PC Retrieve Mode. If the apparatus is in the PC Retrieve Mode, the apparatus will wait for data to be sent to the apparatus from the PC or other storage medium. Upon receiving a successful set of encrypted data, the apparatus will attempt to validate the data it received that was encrypted with the encryption/decipher phrase used to login to the apparatus. If the data is successfully validated, the received backup data set is stored to permanent memory. If the data is not validated, the apparatus discards the data.

Reference L

Reference L, appearing on FIG. 9H, addresses the Add Mode. The apparatus first determines whether it is in the Add Mode. If the apparatus is in the Add Mode, the user selects a category and enters data using the buttons 8 as in the login mode. Once all the fields in the record are stored, the record is encrypted and stored to permanent long term memory 18 using the encryption/decipher phrase used to login to the apparatus.

Reference M

Reference M, appearing on FIGS. 91 and 9J, addresses the Edit Mode. The apparatus first determines whether it is in the Edit Mode. If the apparatus is in the Edit Mode, the Record selected to be edited is highlighted field by field until the desired field to be changed is selected. Characters can be deleted, inserted and added to the original field. When the phrase ‘accept’ is selected, the updated record is encrypted and stored to permanent long term memory 18.

Reference N

Reference N, appearing on FIGS. 9K and 9L, addresses the Find Mode. The apparatus first determines whether it is in the Find Mode. If the apparatus is in the find mode, the login method of selecting characters is used to input a search string. When the phrase ‘done’ is selected from a character set, the first occurrence of the input symbols/characters that matches within a record will display that record. All records with the search characters/symbols will be displayed one-after-the-other as in the View Mode using the up and down pointing arrows.

Interrupt Vector

The interrupt vector, shown on FIG. 9M, is automatically processed when a condition occurs that would allow the microcomputer to recognize the occurrence of an event. Such an event may be the battery crossing a threshold that would indicate the battery is low or critically low. When the microcomputer is in sleep mode, and when enabled, a push of the Menu/On button will generate an interrupt and the apparatus would be made to ‘wake-up’. Another interrupt condition could occur when the microcomputer's watchdog timer expires because a key was not pushed in the last, say, 5 minutes; the apparatus can then be told to power down or sleep.

Create Encryption Phrase Subroutine

The Create Encryption Phrase Subroutine is shown on FIG. 9N. This subroutine is applied when data is entered into the apparatus and the ‘done’ phrase is selected from a character set. The apparatus then will return from the subroutine to continue processing data. This method was shown as a subroutine because it is used to create an encryption phrase, reenter an encryption phrase, change an encryption phrase and re-enter the changed encryption phrase.

Check Buttons Subroutine

The Check Buttons Subroutine is shown by FIG. 9O. The Check Buttons Subroutine provides that when a key is hit in any mode, a watchdog timer is reset. When the watchdog timer overflows, or reaches a threshold, the apparatus is made to automatically power-down.

Check Battery Subroutine

The Check Battery Subroutine is shown by FIG. 9P. The Check Battery Subroutine determines when the battery is low or critically low and takes appropriate action.

A feature of the apparatus is the “pass function.” The pass function allows the user to display information on the apparatus, for example, an account number, and to manually provide the secure data storage apparatus 2 to a second person, for example, a teller in a bank. To initiate the pass function, the user will press a button 8 or make a menu selection. The second person then may read the displayed information from the display 6 of the apparatus 2. If the pass function is initiated, the microprocessor 14 is programmed to power off the apparatus 2 if any button 8 is depressed or menu selection made. The second person therefore is precluded from accessing any information other than the information that the user allows the second person to see. If the second person presses any button or makes any other menu selection, the secure information storage apparatus 2 powers off, erasing the temporary memory 20 and ensuring the safety of the encrypted data stored in long term memory 18.

In describing the above embodiments of the invention, specific terminology was selected for the sake of clarity. However, the invention is not intended to be limited to the specific terms so selected, and it is to be understood that each specific term includes all technical equivalents that operate in a similar manner to accomplish a similar purpose.

I claim:

1. An apparatus for securely storing information, the apparatus comprising:
a. a microprocessor;
b. a long term memory;
c. a temporary memory;
d. a display; and
e. a plurality of buttons, said long term memory, said temporary memory, said display and said plurality of buttons being operably connected to said microprocessor;
said microprocessor being programmed to create a user-selectable data file in response to manipulation of one or more of said plurality of said buttons by a user, said microprocessor being programmed not to create or not to accept said data file created in any other manner;
said microprocessor being programmed to store said data file in said long term memory only in an encrypted form and not to store said data file in said long term memory in any form other than said encrypted form.

2. The apparatus of claim 1 wherein upon selection of a decryption key by said user using said buttons, and only upon selection of said decryption key using said buttons, said microprocessor is programmed to decrypt said encrypted data file stored in said long term memory, to temporarily store said decrypted data file in said temporary memory, and to exhibit said decrypted data file to said user on said display.

3. The apparatus of claim 2, further comprising: means for deactivating the apparatus by the user, said temporary memory being adapted so that said deactivation by said deactivation means erases said decrypted data file from said temporary memory, said permanent memory being adapted so that said deactivation by said deactivation means does not disturb said encrypted data file stored on said long term memory.

4. The apparatus of claim 3, the apparatus further comprising: a port, said port being operably connected to said microprocessor, said port being adapted to be connected to a back-up device, said microprocessor being programmed to transmit said encrypted data file stored in said long term memory to said port and hence to said back-up device only upon a back-up command by said user, said back-up command by said user being conveyed to said microprocessor only by a pre-determined back-up manipulation of one or more of said buttons by said user, whereby said encrypted information may be conveyed to and stored in said back up device.

5. The apparatus of claim 4 wherein said microprocessor is programmed to receive said encrypted data file stored in said back up device only upon a download command by said user, said download command by said user being conveyed to said microprocessor only by a pre-determined download manipulation of one or more of said buttons by said user, whereby said encrypted data file stored on said back up device may be received by said microprocessor through said port and stored in said long term memory.

6. The apparatus of claim 5, further comprising: a case, said case being sized to be readily transportable on a person of said user, said microprocessor, said long term memory and said temporary memory being contained within said case.

7. The apparatus of claim 6, said microprocessor and said long term memory being imbedded in a substantially rigid polymer, whereby removal of said microprocessor or said long term memory from the apparatus by an invader likely will damage said microprocessor or said long term memory, thereby preventing unauthorized access to said encrypted data file.

8. The apparatus of claim 6 wherein said microprocessor and said long term memory are manufactured as a single chip, whereby removal of said microprocessor or said long term memory from the apparatus likely will damage said microprocessor or said long term memory, thereby preventing unauthorized access to said encrypted data file.

9. The apparatus of claim 6 wherein said microprocessor is programmed to apply a predetermined concatenation protocol, said concatenation protocol modifying said decryption key by adding a predetermined sequence of symbols to said decryption key upon encryption of said information, whereby an invader attempting to decrypt said encrypted information obtained from said back-up device must possess both said decryption key and said predetermined sequence of symbols to decrypt said encrypted data file.

10. The apparatus of claim 6 wherein said microprocessor is programmed to require that said user successfully log in to the apparatus prior to said microprocessor allowing said user to perform any operation, the apparatus further comprising: a counter operably connected to or defined by said microprocessor, said counter counting an unsuccessful attempt to log in to the apparatus, said counter resetting to a base number each time a successful log in to the apparatus occurs, said microprocessor erasing said encrypted data file from said long term memory when said counter counts a predetermined number of said unsuccessful log in attempts, whereby a brute force attack by an invader results in erasure of said encrypted data file preventing unauthorized access to said encrypted data file.

11. The apparatus of claim 10 wherein said log in to the apparatus comprises said user selecting said decryption key utilizing only said buttons.

12. The apparatus of claim 6 wherein said plurality of buttons consists of a number of buttons, said number being less than ten.

13. The apparatus of claim 6 wherein said plurality of buttons comprises a plurality of touch surfaces of a touch screen.

14. An apparatus for securely storing information, the apparatus comprising:
a. a microprocessor;
b. a long term memory;
c. a temporary memory;
d. a display; and
e. a plurality of buttons, said long term memory, said temporary memory, said display and said plurality of buttons being operably connected to said microprocessor, said microprocessor being programmed to create a user-selectable data file in response to manipulation of one or more of said plurality of said buttons, said microprocessor being programmed not to create said data file in any other manner, said microprocessor being programmed to store said data file in said long term memory in an encrypted form.

15. The apparatus of claim 14 wherein upon selection of a decryption key using said buttons and only upon said selection of said decryption key using said buttons, said microprocessor is programmed to decrypt said data file stored in said long term memory, to temporarily store said decrypted data file in said temporary memory, and to exhibit said decrypted data file on said display.

16. The apparatus of claim 15 wherein said microprocessor is programmed to require a successful log in prior to said microprocessor allowing said creation of said data file or said decryption and said display of said data file, said log in comprising said selection of said decryption key utilizing said buttons.

17. The apparatus of claim 16 wherein said microprocessor is configured not to multitask during a period of time during which said microprocessor is programmed to allow said creation of said data file or said display of said data file.

18. The apparatus of claim 17 wherein said plurality of buttons comprises a plurality of touch locations on a touch screen.

19. An apparatus for securely storing information, the apparatus comprising:
a. a case, said case being sized to be readily transportable upon a person of a user;
b. a microprocessor contained within said case;
c. a power supply operably connected to said microprocessor;
d. a long term memory operably connected to said microprocessor;
e. a temporary memory operably connected to said microprocessor;
f. a display, said display being operably connected to said microprocessor;
g. a plurality of buttons, said plurality of buttons being operably connected to said microprocessor, said plurality of buttons having a number, said number being less than ten;
h. a port, said port being operably connected to said microprocessor;
i. a log-in attempt counter operably connected to or defined by said microprocessor;
j. said microprocessor being programmed to require a successful log-in by said user prior to allowing any other operation, said log in comprising a pre-determined log-in sequence of manipulations of one or more of said buttons, said log-in sequence further comprising a decryption key;
k. said microprocessor being programmed, upon said successful log-in, to decrypt an encrypted data file stored in said long term memory utilizing said decryption key, to store said decrypted data file in said temporary memory and to selectably display said decrypted data file to said user through said display, said microprocessor being programmed not to decrypt and not to display said data file in an absence of said successful log-in and said entry of said decryption key;
l. said microprocessor being programmed, upon said successful log-in, to allow said user selectably to create or to modify said decrypted data file utilizing said buttons and to selectably save said data file in encrypted form to said long term memory, said microprocessor being programmed not to allow said data file to be created or modified in any other manner, said microprocessor being programmed not to save said data file to said long term memory except in encrypted form;
m. said log-in attempt counter counting an attempt to log in to the apparatus, said log-in counter being reset by said successful log in, said microprocessor erasing said encrypted data file from said long term memory when said log-in counter counts a predetermined number of said unsuccessful log-in attempts.

20. The apparatus of claim 14, the apparatus further comprising: a port, said port being operably connected to said microprocessor, said port being adapted to be connected to a back-up device, said microprocessor being programmed to transmit said encrypted data file stored in said long term memory to said port and hence to said back-up device only upon a back-up command by said user, said back-up command by said user being conveyed to said microprocessor only by a pre-determined back-up manipulation of one or more of said buttons by said user, said microprocessor being programmed to receive said encrypted data file stored in said back up device only upon a download command by said user, said download command by said user being conveyed to said microprocessor only by a pre-determined download manipulation of one or more of said buttons by said user, whereby said encrypted data file may be conveyed to and stored in said back up device and whereby said encrypted data file stored on said back up device may be received by said microprocessor through said port and stored in said long term memory.

21. The apparatus of claim 15 wherein said microprocessor and said long term memory are imbedded in a substantially rigid polymer and wherein said microprocessor and said long term memory are manufactured as a single chip, whereby removal of said microprocessor or said long term memory from the apparatus by an invader likely will damage said microprocessor or said long term memory, thereby preventing unauthorized access to said encrypted data file.

22. The apparatus of claim 16 wherein said microprocessor is programmed to apply a predetermined concatenation protocol, said concatenation protocol modifying said decryption key by adding a predetermined sequence of symbols to said decryption key upon encryption of said information, whereby an invader attempting to decrypt said encrypted data file in the absence of the apparatus must possess both said decryption key and said predetermined sequence of symbols to decrypt said encrypted information.
